(19) United States
(12) Patent Application Publication
(10) Pub. No.: US 2020/0072712 A1
(43) Pub. Date: Mar. 5, 2020

(54) TISSUE MINCERS, RELATED SYSTEMS, AND RELATED METHODS

(71) Applicant: PREDICTIVE TECHNOLOGY GROUP, INC., Salt Lake City, UT (US)

(72) Inventors: Eric K. Olson, Salt Lake City, UT (US); Douglas I. Schmid, Sandy, UT (US); LeVoy G. Haight, West Jordan, UT (US); J. Ken Barton, Sandy, UT (US); Aaron M. Best, Murray, UT (US)

(73) Assignee: Predictive Technology Group, Inc., Salt Lake City, UT (US)

(21) Appl. No.: 16/546,028

(22) Filed: Aug. 20, 2019

Related U.S. Application Data
(60) Provisional application No. 62/724,444, filed on Aug. 29, 2018.

(51) Int. Cl. G01N 1/31

(52) U.S. Cl. CPC G01N 1/31

(57) ABSTRACT

A tissue mincer includes a canister defining a chamber and an opening, a lid configured to cover the opening, and a tissue cutter. The tissue cutter includes a shaft and a blade assembly. The shaft includes a proximal portion that is configured to be rotated and a distal portion extending into the chamber when the tissue mincer is assembled. The distal portion is coupled to the blade assembly. The blade assembly includes a first disk, at least one blade spaced from the distal portion of the shaft by the first disk, and a disk retainer that encloses at least a portion of the blade. The blade can rotate relative to at least the first disk when the proximal portion of the shaft rotates. The blade includes at least one cutting edge that is configured to cut tissue as the blade rotates.

### RELATED APPLICATION

This application claims the benefit of U.S. Provisional Application No. 62/724,444, filed on 29 Aug. 2018, which is incorporated by reference herein in its entirety

### BACKGROUND

Obtaining viable cells, such as stem cells, from tissue can be a difficult process. Typically, viable cells can be obtained by mincing the tissue in a laminar hood or using a conventional mechanical tissue mincer. However, these devices have specific drawbacks that limit their use in laboratories or industries.

For example, obtaining viable cells from a laminar hood can be a time consuming process. The long time required to obtain the viable cells can reduce the number of viable cells that is obtained. Further, the laminar hood can occupy a relatively large volume thereby consuming valuable space in a laboratory or other room.

The conventional mechanical tissue mincers can, in some areas, be superior to laminar hoods since they can mince tissue quickly and occupy less space than the laminar hood. However, conventional tissue mincers also have their drawbacks. For example, the conventional tissue mincers can require large amounts of saline solution to process the tissue and the saline may need to be removed from the minced tissue. The extra time and/or processing required to remove the large amounts of saline solution can decrease the number of viable cells that are obtained from the tissue. Additionally, conventional mechanical tissue mincers have difficulty mincing the tissue into uniform sizes. The lack of the uniform size of the minced tissue can, among other things, increase the amount of tissue that remains in the conventional mechanical tissue mincer, make removing minced tissue from the conventional mechanical tissue mincer more difficult, and potentially limit the application of the minced tissue. Also, conventional mechanical tissue mincers may leave significant amounts of minced tissue in the mincer. Further, conventional mechanical tissue mincers can also contaminate the viable cells, for example, with metal from the blades used to mince the tissue.

Therefore, users and manufacturers of viable cells continue to seek new and improve apparatuses and methods for obtaining viable cells from tissue.

### SUMMARY

In an embodiment, a tissue mincer is disclosed. The tissue mincer includes a canister including at least one bottom surface and at least one lateral surface extending from the at least one bottom surface. The at least one bottom surface and the at least one lateral surface at least partially define a chamber. The canister defines an opening. The tissue mincer also includes a lid configured to be reversibly attached to the canister and sized to be disposed over the opening. Additionally, the tissue mincer includes a tissue cutter comprising a shaft and a blade assembly. The shaft includes a proximal portion and a distal portion longitudinally spaced from the proximal portion. The proximal portion is configured to rotate and the distal portion extends into the chamber when the tissue mincer is fully assembled. The blade assembly includes a first disk defining a plurality of holes. The first disk is positioned adjacent to the distal portion of the shaft. The blade assembly also includes at least one blade spaced from the distal portion of the shaft by the first disk. The at least one blade includes at least one cutting edge and a lateral periphery. The at least one blade is configured to rotate relative to the first disk when the proximal portion of the shaft rotates. The blade assembly also includes a blade retainer including a base portion and at least one outer wall extending from the base portion. The at least one outer wall is configured to enclose at least a portion of the lateral periphery of the at least one blade. The blade retainer is configured to be coupled to the first disk.

In an embodiment, a system is disclosed. The system includes a tissue mincer. The tissue mincer includes a canister including at least one bottom surface and at least one lateral surface extending from the at least one bottom surface. The at least one bottom surface and the at least one lateral surface at least partially define a chamber. The canister defines an opening. The tissue mincer also includes a lid configured to be reversibly attached to the canister and sized to be disposed over the opening. Additionally, the tissue mincer includes a tissue cutter comprising a shaft and a blade assembly. The shaft includes a proximal portion and a distal portion longitudinally spaced from the distal portion. The proximal portion is configured to rotate and the distal portion extends into the chamber when the tissue mincer is fully assembled. The blade assembly includes a first disk defining a plurality of holes. The first disk is positioned adjacent to the distal portion of the shaft. The blade assembly also includes at least one blade spaced from the distal portion of the shaft by the first disk. The at least one blade including at least one cutting edge and a lateral periphery. The at least one blade is configured to rotate relative to the first disk when the proximal portion of the shaft rotates. Additionally, the blade assembly includes a blade retainer including a base portion and at least one outer wall extending from the base portion. The at least one outer wall configured to enclose at least a portion of the lateral periphery of the at least one blade. The at least one outer wall is configured to be coupled to the first disk. The system also includes a motor operably coupled to the proximal portion of the shaft. The motor configured to controllably at least one of controllably rotate the proximal portion of the shaft relative to the canister at a selected speed or controllably move the shaft up and/or down relative to the canister to at least one of move the shaft up and/or down relative to the canister at a selected speed or apply a selected pressure with the blade assembly to a tissue that is disposed in the chamber.

In an embodiment, a method of operating a tissue mincer is disclosed. The method includes disposing a tissue in a chamber of a canister of the tissue mincer. The canister can be vertically oriented. The canister includes at least one bottom surface and at least one lateral surface extending from the at least one bottom surface. The at least one bottom surface and the at least one lateral surface at least partially defines the chamber. The method also includes disposing a portion of a tissue cutter of the tissue mincer in the chamber. The tissue cutter includes a shaft and a blade assembly. The shaft includes a proximal portion and a distal portion longitudinally spaced from the proximal portion. The proximal portion is configured to rotate and the distal portion extends into the chamber. The blade assembly includes a first disk defining a plurality of holes. The first disk is positioned adjacent to the distal portion of the shaft. The blade assembly also includes at least one blade spaced from the distal portion of the shaft by the first disk. The at least one blade includes at least one cutting edge and a lateral periphery. Additionally, the blade assembly includes a blade retainer including a base portion and at least one outer wall extending from the base portion. The at least one outer wall is configured to enclose at least a portion of the lateral periphery of the at least one blade. The at least one outer wall is configured to be coupled to the first disk. The method also includes rotating the distal portion of the shaft relative to the canister and moving the shaft up and/or down relative to the canister. Rotating the distal portion of the shaft relative to the canister causes the at least one blade to rotate relative to the first disk. Moving the shaft up and/or down relative to the canister causes the at least one blade to move up and/or down relative to the tissue disposed in the chamber. The method further includes cutting the tissue with the at least one cutting edge of the at least one blade.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIGS. 1A and 1B are an isometric view and an exploded view of a tissue mincer 100, according to an embodiment.

FIG. 1C is an isometric view of the canister 102 shown in FIGS. 1A and 1B, according to an embodiment.

FIG. 1D is an exploded view of the tissue cutter 106 illustrating the components of the blade assembly 110, according to an embodiment.

FIG. 1E is an isometric view illustrating an opposing side of the blade retainer 144 shown in FIG. 1D, according to an embodiment.

FIG. 2 is an exploded isometric view of a tissue cutter 206, according to an embodiment.

FIG. 3 is a schematic illustration of a system 387 that includes a tissue mincer 300, according to an embodiment.

FIG. 4 is a flow chart of a method 400 of using any of the tissue mincers disclosed herein, according to an embodiment.

### DETAILED DESCRIPTION

This disclosure is drawn, inter alia, to methods, systems, products, devices, and/or apparatuses generally related to tissue mincers. An example tissue mincer includes a canister defining a chamber and an opening, a lid configured to cover the opening, and a tissue cutter. The tissue cutter includes a shaft and a blade assembly. The shaft includes a proximal portion that is configured to be rotated and a distal portion extending into the chamber when the tissue mincer is assembled. The distal portion is coupled to the blade assembly. The blade assembly includes a first disk, at least one blade spaced from the distal portion of the shaft by the first disk, and a disk retainer that encloses at least a portion of the blade. The first disk defines a plurality of holes sized to allow minced tissue (i.e., tissue cut by the blade of the blade assembly) having a preselected particle size or less pass through the holes. The blade can rotate relative to at least the first disk when the proximal portion of the shaft rotates. The blade includes at least one cutting edge that is configured to cut tissue as the blade rotates. The blade retainer is configured to at least partially enclose a lateral periphery of the blade. The blade retainer can suppress at least one of movement (e.g., wobbling) of the blade, tissue flowing around the blade thereby bypassing the blade, or tissue getting stuck in the blade assembly which can cause the blade to lose efficiency.

During operation, a tissue is disposed in the chamber of the canister through the opening. The canister can be oriented vertically with the opening at the top of the canister. The lid can be disposed over the opening to prevent the tissue from leaving the chamber. After disposing the tissue in the chamber, a portion of the tissue cutter can be disposed in the chamber such that tissue is disposed below the blade assembly of the tissue cutter (e.g., the tissue is positioned between a bottom surface of the chamber and the blade assembly). The distal portion of the shaft can then be rotated relative to the canister and the shaft can be move up and/or down relative to at least one of the canister, the lid, or the tissue. Rotating the proximal portion of the shaft causes the blade to rotate and moving the shaft up and/or down can cause the rotating blade to move relative to and contact the tissue thereby cutting the tissue.

In an embodiment, the tissue mincers disclosed herein can form part of a system. The system can include the tissue mincer and a motor. The motor can be configured to be operably coupled to the proximal portion of the shaft. The motor can be configured to at least one rotate the proximal portion of the shaft or move the shaft up and/or down relative to the canister. The particle size of the minced tissue can vary depending, in part, on the speed that the blade rotates, the speed that the blade moves up and/or down, and the pressure that the blade assembly applies to the tissue. Further, at least one of rotating the blade at a selected speed (e.g., constant speed or controllably varying the speed), moving the blade up and/or down at a selected speed (e.g., constant speed or controllably varying the speed), or applying a selected pressure (e.g., constant pressure or controllably varying the pressure) applied to the tissue with the blade assembly can affect particle size, either causing the tissue to exhibit a substantially uniform particle size or vary the size of tissue particles, depending on changes to these variables. For example, the particles can exhibit a substantially uniform particle size when the particle size of the minced tissue exhibits a standard deviations of less than about 2 mm, such as less than about 1 mm, less than about 0.5 mm, less than about 0.1 mm, or in ranges of about 0.1 mm to about 2 mm, about 0.1 mm to about 0.3 mm, about 0.2 mm to about 0.4 mm, about 0.3 mm to about 0.5 mm, about 0.4 mm to about 0.7 mm, about 0.6 mm to about 1 mm, about 0.8 mm to about 1.3 mm, about 1 mm to about 1.5 mm, about 1.3 mm to about 1.7 mm, or about 1.5 mm to about 2 mm. The uniform particle size of the tissue can optimize the percentage of stem cells that are extracted from the tissue since extraction of the stem cells from the tissue can include flowing the minced tissue through a filter. The substantially uniform particle size can be selected to be within a certain range of particle sizes that the filter is designed to handle which, in turn, makes the extraction of the stem cells more efficient. In some embodiments, consistent blade speed and consistent vertical movement of the blade assembly can produce uniform particle size. Unlike a manual (e.g., human operated) device, the motor can be configured to perform at least one of the following: rotate the blade at a selected speed, move the blade up and/or down at a selected speed, or apply a selected pressure to the tissue with the blade assembly. In an embodiment, the motor can include or be coupled to a controller that at least partially controls the operation of the motor. The controller can include an input device that allows a user of the system to input one or more operation instructions into the controller, such as at least one of the selected speed(s) that the blade rotates, the selected speed that the blade assembly moves up and/or down, or the selected pressure that the blade assembly applies to the tissue.

The tissue mincer can be used to mince any suitable tissue. In an embodiment, the tissue mincer can be used to cut umbilical cords, placentas, or other tissue that is rich in stem cells. In an embodiment, the tissue mincer can be used to mince other types of tissue, such as muscle tissue, brain, liver, other organs, non-human tissue, sirloin steak, or any other suitable issue.

The tissue mincers disclosed herein can be formed of any suitable material. For example, the tissue mincers disclosed herein can be formed from at least one metal (e.g., stainless steel, carbon steel, or aluminum), at least one polymer (e.g., polycarbonate or nylon), at least one ceramic (e.g., silicon carbide or silicon nitride), at least one composite (e.g., a glass fiber reinforced polymer), or combinations thereof. In an embodiment, the components of the tissue mincers that may contact tissue during operation can be formed from one or more biocompatible materials. For example, at least one the portions of the canister than define the chamber, the blade assembly, and at least a portion of the shaft can be formed from biocompatible materials.

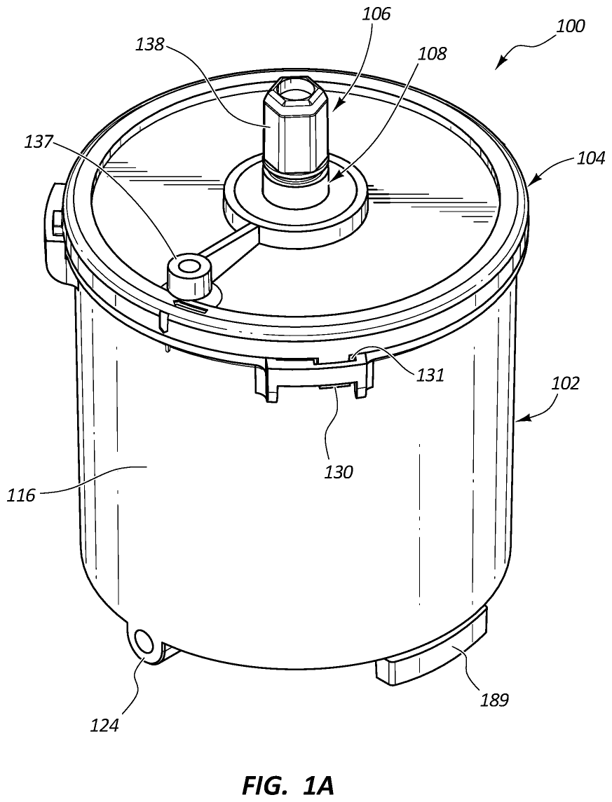

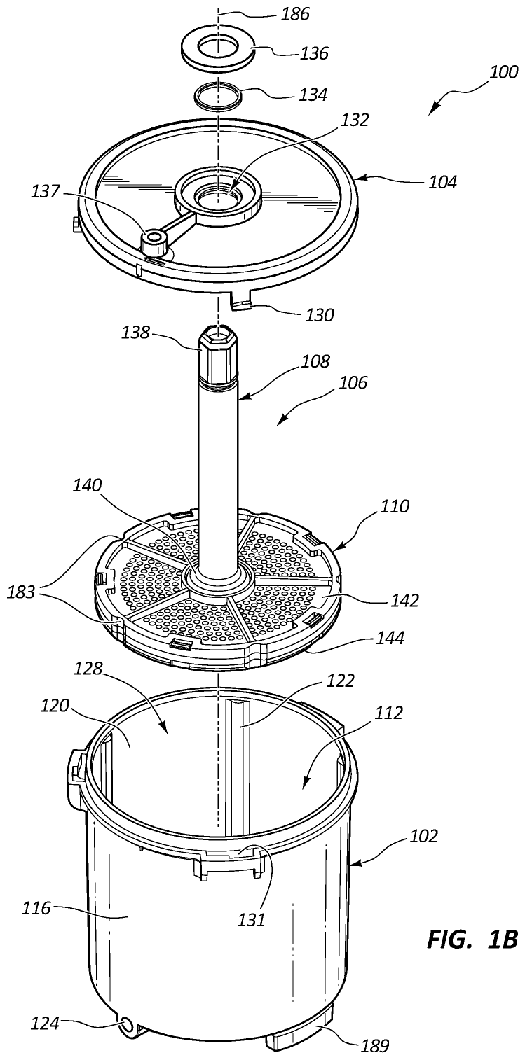

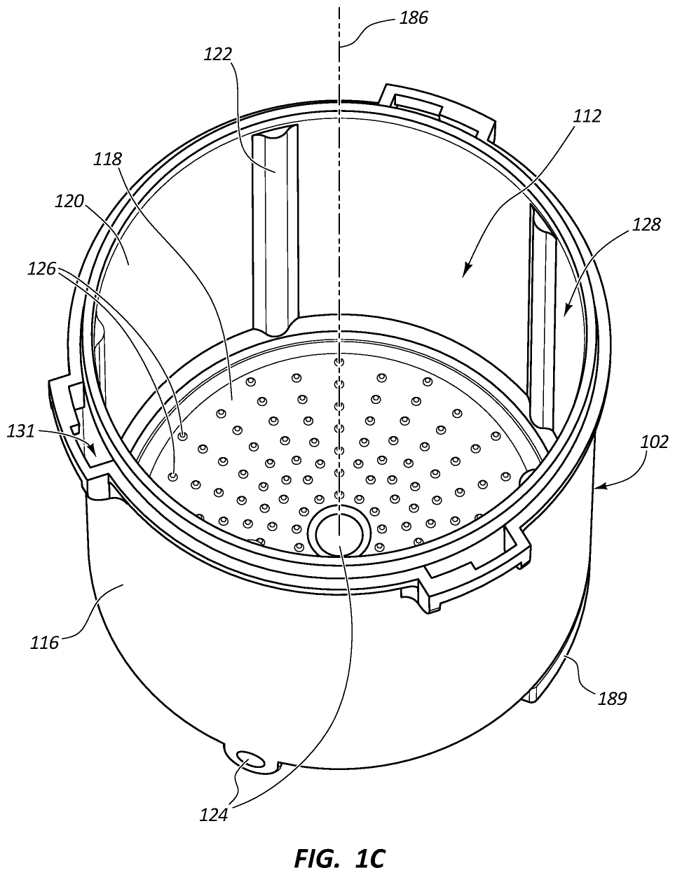

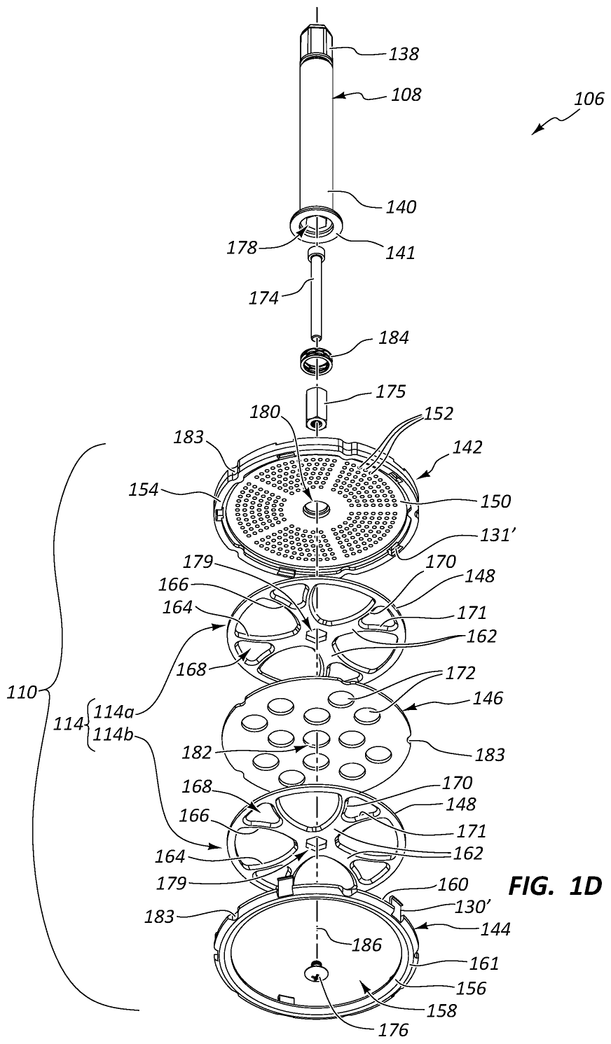

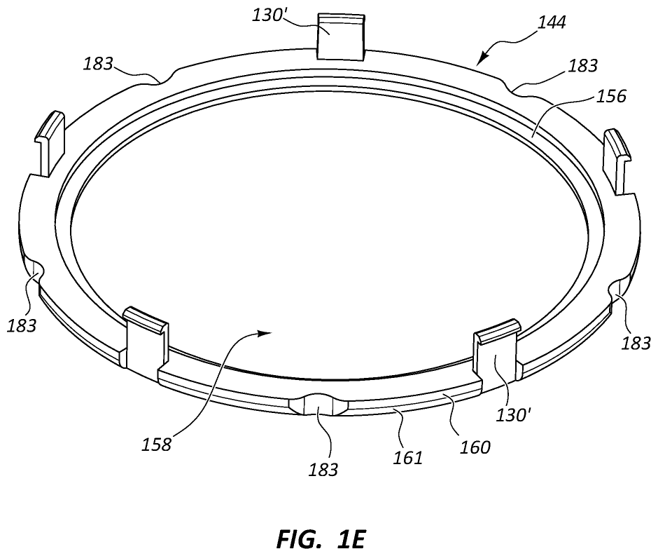

FIGS. 1A and 1B are an isometric view and an exploded view of a tissue mincer 100, according to an embodiment. The tissue mincer 100 includes a canister 102 defining a chamber 112 that can receive tissue, a lid 104, and a tissue cutter 106 including a shaft 108 and a blade assembly 110. The shaft 108 of the tissue cutter 106 can move (e.g., rotate and translate up and/or down). Moving the shaft 108 can also move a plurality of blades 114 (shown in FIG. 1D) which, in turn, can cause the blades 114 to cut the tissue that is in the chamber 112.

FIG. 1C is an isometric view of the canister 102 shown in FIGS. 1A and 1B, according to an embodiment. The canister 102 can include one or more walls 116. The one or more walls 116 can define at least one bottom surface 118 and at least one lateral surface 120 extending from the bottom surface 118. The bottom surface 118 and the lateral surface 120 of the canister 102 can partially define the chamber 112. The chamber 112 can exhibit any suitable shape. In an embodiment, the chamber 112 can be generally cylindrical in shape and can be oriented vertically having an opening 128 at the top end. In such an embodiment, the bottom surface 118 can be generally planar and the lateral surface 120 can exhibit a generally cylindrical shape. The generally cylindrical shape of the chamber 112 can allow the blade assembly 110 to move up and/or down in the chamber 112. Also, since the blades 114 exhibits a generally circular configuration or shape, the generally cylindrical shape of the chamber 112 can allow the blades 114 to remain proximate to the lateral surface 120 as the blades 114 rotate. However, in other embodiments, the chamber 112 can exhibit other suitable shapes. In an example, as illustrated, the lateral surface 120 can include one or more protrusions 122 extending therefrom that prevent the lateral surface 120 form forming a cylindrical surface. The protrusions 122 can limit laminar flow of the tissue in the chamber 112 during operation which can facilitate the formation of minced tissue exhibiting a substantially uniform particle size. Also, the protrusions 122 can suppress movement of the tissue in the chamber 112 which, in turn, can decrease the time required to cut the tissue. In an example, the bottom surface 118 can exhibit a generally concave shape which directs minced tissue toward an outlet 124 of the canister 102.

The chamber 112 can exhibit a height measured from a bottommost portion of the bottom surface 118 and a maximum lateral dimension (e.g., width or diameter) which, in part, determines the volume of the chamber 112. In an example, the chamber 112 can exhibit a height and/or maximum lateral dimension of about 2 cm to about 50 cm, such as in ranges of about 2 cm to about 5 cm, about 4 cm to about 7 cm, about 5 cm to about 10 cm, about 7 cm to about 12 cm, about 10 cm to about 15 cm about 12 to about 17 cm, about 15 to about 20 cm, about 17 cm to about 25 cm, about 20 cm to about 30 cm, about 25 cm to about 35 cm, about 30 cm to about 40 cm, about 35 cm to about 45 cm, or about 40 cm to about 50 cm. The height and maximum lateral dimension of the chamber 112 can be the same or different. The height and maximum lateral dimension of the chamber 112 can be selected based on the amount of tissue that the tissue mincer 100 is configured to mince. In an example, the height and/or maximum lateral dimension of the chamber 112 can be relatively small (e.g., about 2 cm to about 15 cm) if the chamber 112 is configured hold a small amount of tissue, such as just a portion of an umbilical cord. In an example, the height and/or maximum lateral dimension of the chamber 112 can be relatively larger (e.g., about 10 cm to about 50 cm or about 15 cm to about 50 cm) if the chamber 112 is configured to hold a large amount of tissue, such as a whole placenta.

The bottom surface 118 of the canister 102 can include one or more friction features 126 that are configured to suppress movement of the tissue during operation. For example, the friction features 126 can prevent the tissue from spinning, tumbling, or otherwise moving during operation which can decrease the efficiency of the tissue mincer 100. In the illustrated embodiment, the friction features 126 can include one or more projections (e.g., spikes, hooks, etc.). However, the friction features 126 can include a material having a high kinetic and/or static friction coefficient with the tissue, one or more ridges, one or more recesses, or any other suitable feature.

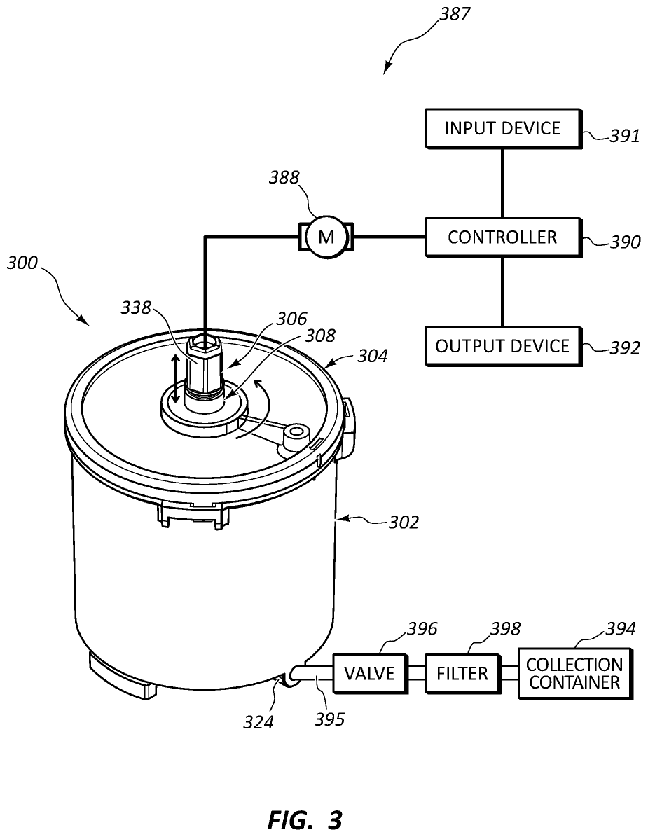

The bottom surface 118 of the canister 102 can also at least partially define an outlet 124. The outlet 124 is typically located at or near a bottommost portion (e.g., relative to gravity) of the bottom surface 118. As such, the minced tissue can flow into the outlet 124 with limited pooling of the minced tissue in regions of the chamber 112 that are spaced from the outlet 124. Pooling of the minced tissue can make effective recovery of the minced tissue difficult and/or time consuming. The outlet 124 can be configured to be coupled to a collection device, as discussed in more detail with regards to FIG. 3.

As previously discussed, the canister 102 defines an opening 128. For example, the lateral surface 120 of the canister 102 can define the opening 128. The opening 128 can at least provide one of the following: allow the tissue to be disposed in the chamber 112, allow at least the blade assembly 110 of the tissue cutter 106 to be disposed in the chamber 112, facilitate removal of any minced tissue that did not exit the chamber 112 via the outlet 124, or enable cleaning of the chamber 112. The opening 128 can allow tissue (e.g., minced tissue) to exit the chamber 112 during operation. As such, referring back to FIGS. 1A and 1B, the tissue mincer 100 can include a lid 104. The lid 104 can be sized to cover the opening 128 thereby preventing tissue from exiting the chamber 112 while the lid 104 covers the opening 128.

The lid 104 can be configured to be reversibly coupled to the canister 102. The lid 104 is reversibly coupled to the canister 102 when the lid 104 can be coupled to and decoupled from the canister 102 substantially without damaging the canister 102 and the lid 104. In an embodiment, the canister 102 and the lid 104 can include one or more attachment devices that enable the lid 104 to be reversibly coupled to the canister 102. In an example, as illustrated, the attachment devices can include one or more hooks 130 extending from one of the canister 102 or lid 104 and one or more corresponding recesses 131 formed in the other of the canister 102 or lid 104. The corresponding recesses 131 are configured to receive the hooks 130. In an example, the attachment devices can include threads on one of the canister 102 or the lid 104 and one or more corresponding recesses on the other of the canister 102 or the lid 104 that are configured to receive the threads. In an example, the attachment devices can include a latch, another mechanical fastener, magnets, or another suitable attachment device.

The lid 104 can define a shaft opening 132 that is configured to receive the shaft 108 of the tissue cutter 106. The shaft opening 132 can allow at least a portion of the shaft 108 to be disposed outside of the chamber 112 while the blade assembly 110 is disposed in the chamber 112. The shaft opening 132 can exhibit a size and shape that is the same size as or slightly larger than the shaft 108. As such, the shaft opening 132 can allow the shaft 108 to be at least one disposed through and removed from the lid 104, move up and/or down relative to the lid 104, or rotate relative to the lid 104. The lid 104 can also include one or more elements that are configured to limit or prevent tissue and/or fluid (e.g., saline solution) exiting the chamber 112 through a gap between the periphery of the lid 104 that defines the shaft opening 132 and the shaft 108. For example, the lid 104 can include an O-ring 134 and/or a bearing retainer 136 that, collectively, are configured to substantially limit the tissue and/or fluid from exiting the chamber by at least partially filling the gap between the periphery of the lid 104 that defines the shaft opening 132 and the shaft 108.

The lid 104 can define an inlet 137. The inlet 137 can allow one or more materials to be added to the chamber 112 after the lid 104 is coupled to the canister 102. The one or more materials can include a fluid, such as saline solution. However, the one or more materials can further include tissue or other solids. In an embodiment, the inlet 137 is located on a portion of the lid 104 that is spaced from a center of the lid 104. In such an embodiment, the position of the inlet 137 can facilitate access to the inlet 137 during operation and so the inlet 137 does not interfere with the operation of a motor operably coupled to the shaft 108. Further, spacing the inlet 137 from a center of the lid 104 can allow the shaft opening 132 to be at or near the center of lid 104 which can facilitate rotation of the blades 114.

FIG. 1D is an exploded view of the tissue cutter 106 illustrating the components of the blade assembly 110, according to an embodiment. The tissue cutter 106 include a shaft 108 and a blade assembly 110 coupled to the shaft 108. In an embodiment, the tissue cutter 106 can also include one or more connection components that are configured to attach the blade assembly 110 to the shaft 108.

The shaft 108 can exhibit a longitudinal shape and include a proximal portion 138 and a distal portion 140 that is longitudinally spaced from the proximal portion 138. The proximal portion 138 of the shaft 108 can be configured to be operably coupled to a motor or other device (e.g., hand crank) that is configured to rotate at least a portion of the shaft 108. In an example, as illustrated, the proximal portion 138 of the shaft 108 can exhibit a hexagonal or other suitable shape that is configured to be inserted into a recess of the motor or other device exhibiting a corresponding shape (e.g., a six- or twelve-pointed recess when the proximal portion 138 exhibits a hexagonal shape). In an example, the proximal portion 138 can define a recess that is configured to receive a correspondingly shape protrusion of the motor or other device, a shape that is configured to interface with a chain, a region that is configured to connect to a belt, or any other suitable structure that allows the proximal portion 138 to be operably coupled to the motor or the other device.

In an embodiment, rotating the proximal portion 138 can cause the distal portion 140 to also rotate. In such an embodiment, the shaft 108, for example, can exhibit single piece construction or the proximal portion 138 and the distal portion 140 can form different pieces that are attached together in a manner that causes both the proximal and distal portions 138, 140 to rotate. In an embodiment, rotating the proximal portion 138 does not cause the distal portion 140 to rotate. In such an embodiment, the proximal and distal portions 138, 140 can be distinct pieces of the shaft 108. For example, the distal portion 140 can form a housing and the proximal portion 138 can be coupled to an elongated member that extends through the distal portion 140 and rotates when the proximal portion 138 rotates. Forming the distal portion 140 to be a housing can reduce the number of moving parts that are exposed since the exposed moving parts can create work safety hazards.

The distal portion 140 of the shaft 108 is configured to contact the blade assembly 110 and be attached to the blade assembly 110 using any suitable attachment method (e.g., adhesive, mechanical attachment, etc.). The distal portion 140 can also be configured to prevent the blade assembly 110 from moving up and/or down the shaft 108. In an example, the distal portion 140 of the shaft 108 can exhibit a maximum lateral dimension (e.g., diameter) at a terminal portion thereof that is sufficiently large to prevent the blade assembly 110 from moving up the shaft 108. Increasing the maximum lateral dimension at a terminal portion of the distal portion 140 of the shaft 108 can also suppress movement (e.g., wobbling) of the blade assembly 110 relative to the shaft 108 during operation. Moving the blade assembly 110 relative to the shaft 108 can cause the blade assembly 110 to become jammed or result in damage to the tissue cutter 106 or the canister 102. To increase the maximum lateral dimension of terminal portion of the distal portion 140, the distal portion 140 can include a flared structure 141 at a terminal portion thereof that increases the maximum lateral dimension thereof.

The blade assembly 110 can include a first disk 142, a plurality of blades 114 (e.g., a first blade 114a and a second blade 114b), a blade retainer 144, and at least one second disk 146 disposed between the plurality of blades 114. The first disk 142 can be positioned between the blades 114 and the distal portion 140 of the shaft 108. The blade retainer 144 can be configured to be attached to the first disk 142 such that the blades 114 are disposed between the first disk 142 and the blade retainer 144. The blade retainer 144 can be connected to the first disk 142 in a manner such that at least a portion of the blade retainer 144 and/or the first disk 142 encloses at least a portion a lateral periphery 148 of the blades 114. Enclosing at least a portion of the lateral periphery 148 of the blades 114 with the blade retainer 144 and/or the first disk 142 can limit or prevent at least one of the following from occurring: tissue moving around the lateral periphery 148 of the blades 114, tissue getting trapped between the blades 114 and the first disk 142 and/or the second disk 146, tissue getting stuck on the lateral surface 120, or the blades 114 wobbling (e.g., the blade retainer 144 can maintain spatial control between the blades 114 and the first and second disks 142, 146). As such, enclosing at least a portion of the lateral periphery 148 of the blades 114 with the blade retainer 144 can allow the blade assembly 110 to form minced tissue exhibiting a more uniform particle size of, suppress degradation of the viable cells, increase the amount of minced tissue that is recovered, and improve the overall function and efficiency of the tissue mincer 100.

The first disk 142 includes a first base portion 150. The first base portion 150 is positioned adjacent to the distal portion 140 of the shaft 108. The first base portion 150 can define a plurality of first holes 152 therein. The first holes 152 can exhibit a size that corresponds to the maximum allowable size of the minced tissue. For example, the first holes 152 can exhibit a maximum lateral dimension (e.g., diameter) that is about 500 μm to about 1 cm, such as in ranges of about 500 μm to about 1 mm, about 750 μm to about 1.5 mm, about 1 mm to about 2 mm, about 1.5 mm to about 3 mm, about 2 mm to about 4 mm, about 3 mm to about 6 mm, or about 5 mm to about 1 cm. For instance, during operation, the first base portion 150 can separate the chamber 112 into a cutting region and a non-cutting region. The cutting region is between the first base portion 150 and the bottom surface 118 of the canister 102 and the non-cutting region is between the first base portion 150 and the lid 104. The portion of the tissue that is in the cutting region of the chamber 112 is exposed to the rotating blade(s) 114 during operation and, as such, can be cut. However, once the tissue is minced to a size that is less than the size of the first apertures or holes 152, the tissue can flow from the cutting region into the non-cutting region through the first holes 152. Minced tissue that is present in the non-cutting region of the chamber 112 is not exposed to the blades 114 and, as such, is not cut. However, it is noted that the minced tissue can flow from the non-cutting region back into the cutting region during operation, for example, when the blade assembly is moved up or otherwise transitions away from the bottom surface 118 of the canister 102. As such, the blade assembly 110 can cut the tissue to a particle size that is less than (e.g., significantly less than) the size of the first holes 152.

The first disk 142 can also include a first outer wall 154 extending from the first base portion 150. The first outer wall 154 can be configured to enclose at least a portion of the lateral periphery 148 of the blades 114. For example, the first outer wall 154 can include an inner surface that exhibits shapes that correspond to the shapes of the blades 114 as the blades 114 rotate.

FIG. 1E is an isometric view illustrating an opposing side of the blade retainer 144 shown in FIG. 1D, according to an embodiment. The blade retainer 144 includes a second base portion 156. The second base portion 156 defines an inlet 158 of the blade assembly 110. The inlet 158 can exhibit a maximum lateral dimension (e.g., diameter) that is smaller than but comparable to the maximum lateral dimension of the chamber 112 which can allow the tissue to enter the blade assembly 110 substantially without hindrance. In an example, the inlet 158 can exhibit a maximum lateral dimension that is about 0.5% to about 50% smaller than the maximum lateral dimension, such as in ranges of about 0.5% to about 5%, about 2.5% to about 7.5%, about 5% to about 10%, about 7.5% to about 12.5%, about 10% to about 15%, about 12.5% to about 17.5%, about 15% to about 20%, about 17.5% to about 22.5%, about 20% to about 25%, about 22.5% to about 27.5%, about 25% to about 30%, about 27.5% to about 35%, about 30% to about 40%, about 35% to about 45%, or about 40% to about 50%. The inlet 158 can also be slightly smaller than blades 114 thereby preventing the blades 114 from leaving the blade assembly 110 via the inlet 158.

The blade retainer 144 can also include at least one second outer wall 160 extending from the second base portion 156. The second outer wall 160 can be configured to enclose at least a portion of the lateral periphery 148 of the blades 114. For example, the second outer wall 160 can include an inner surface that exhibits a shape that corresponds to the shape of the blades 114 as the blades 114 rotate. As such, the second outer wall 160 can suppress or prevent tissue from flowing around the blades 114.

In an embodiment, the blade assembly 110 only includes the first outer wall 154 where the second outer wall 160 is omitted from the blade assembly 110. In such an embodiment, the first outer wall 154 can partially or completely enclose the lateral periphery 148 of the blade assembly 110. In an embodiment, the blade assembly 110 only includes the second outer wall 160 and the first outer wall 154 is omitted from the blade assembly 110. In such an embodiment, the second outer wall 160 can partially or completely enclose the lateral periphery 148 of the blade assembly 110.

As previously discussed, the blade retainer 144 is configured to be attached to the first disk 142. The blade retainer 144 and the first disk 142 can be configured to be attached together using any suitable method, such as using any of the attachment devices disclosed herein. For example, as illustrated, the blade retainer 144 can include one or more hooks 130′ extending from the second outer wall 160 and the first base portion 150 and/or the first outer wall 154 defines one or more corresponding recesses 131′ that are configured to receive the hooks 130′.

Referring back to FIG. 1D, the blade retainer 144 can include a chamfer 161 on the convex corner where the second base portion 156 and the second outer wall 160 meet. The chamfer 161 can facilitate insertion of the blade assembly 110 into the chamber 112, especially when the blade assembly 110 exhibits a shape and size that substantially corresponds to the shape and size of the chamber 112. Further, the chamfer 161 of the blade retainer 144 can prevent the convex corner from digging into the lateral surface 120 which can damage the blade retainer 144, cause the blade retainer 144 to deform into the blades 114, or damage the lateral surface 120. The blade retainer 144 can include a round surface or other suitable shape instead of the chamfer 161.

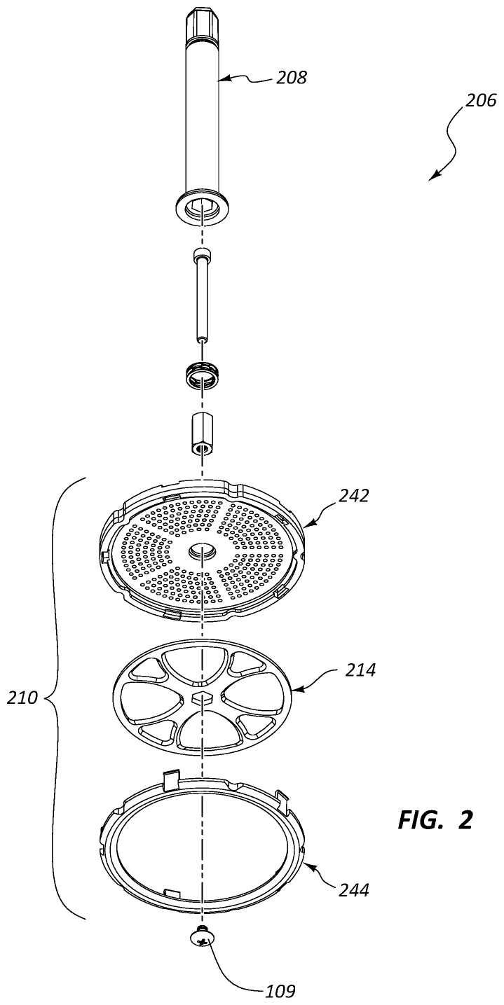

As previously discussed, the blade assembly 110 includes a plurality of blade 114. The blade assembly 110 can include any suitable number of the blades 114. For example, as illustrated, the blade assembly 110 can include a first blade 114a and a second blade 114b. However, the blade assembly 110 can include more than two blades 114 (e.g., three, four, five, six, or more than six blades 114). Generally, increasing the number of blades 114 in the blade assembly 110 can cause the blade assembly 110 to cut the tissue into smaller pieces in a single pass than a blade assembly 110 that includes fewer blades 114. However, increasing the number of blades 114 in the blade assembly 110 can increase at least one of the complexity of the blade assembly 110, the likelihood that at least one of the blades 114 gets jammed, or the amount of tissue that remains in the blade assembly 110. As such, for example, the blade assembly 110 may include fewer than three blades 114. As will be discussed in more detail with regard to FIG. 2, the blade assembly 110 can also include a single blade. In an embodiment, the first blade 114a of the blades 114 can be offset relative to the second blade 114b to facilitate cutting of the tissue.

Each of the blades 114 can include a plurality of spokes 162 that extend from a central location of the blades 114 (e.g., central hole 179) toward the lateral periphery 148 of the blades 114. The spokes 162 can extend from the central location in any suitable manner. For example, the spokes 162 can extend from the central portion in a radial manner, a spiral manner, a tapered manner (e.g., tapers to or from the central location), or in any other suitable manner. In an embodiment, at least one of the spokes 162 can extend from the central location of the blades 114 to the lateral periphery 148 of the blades 114. In such an embodiment, the spoke 162 can define or be coupled to (e.g., attached to or integrally formed with) the lateral periphery 148. For example, the spoke 162 can be coupled to a lateral periphery 148 of the blades 114. The spoke 162 can be annular in shape. In such an example, the lateral periphery 148 can interconnect at least some of the spokes 162 together and can limit vibrations in the spokes 162 which could otherwise cause the spokes 162 to inadvertently contact and damage at least one of the first disk 142, the blade retainer 144, the second disk 146, or another blade 114. In an embodiment, one or some of the spokes 162 do not extend to all the way to the lateral periphery 148 of the blades 114.

The blades 114 can include any number of spokes 162. In an example, as illustrated, each of the blades 114 can include four spokes 162. However, it is noted that at least one of the blades 114 can include few than four spokes 162 (e.g., two or three spokes 162) or more than four spokes 162 (e.g., five or six spokes 162).

The spokes 162 each includes a first edge 164 that generally faces a first rotational direction of the blades 114 and a second edge 166 that generally faces a second rotational direction of the blades 114. At least one of the first edge 164 or the second edge 166 can be sharpened to form the at least one cutting edge of the blades 114. The cutting edge of the blades 114 can be configured to cut the tissue that is disposed in the chamber 112. In an embodiment, only one of the first edge 164 or the second edge 166 of at least one (e.g., all) of the spokes 162 is a cutting edge. In such an embodiment, the blades 114 may only be able to cut the tissue when the blades 114 rotates in one certain direction. In an embodiment, both the first and second edges 164, 166 are cutting edges. In such an embodiment, the blades 114 may be able to cut the tissue when the blades 114 rotate in both directions. Rotating the blades 114 in both directions can cause the blades 114 to cut the tissue more quickly. Rotating the blades 114 in both direction can also facilitate getting the blades 114 unjammed or otherwise release trapped tissue within the blade assembly 110. For example, the tissue that is present in the chamber 112 can jam the blades 114 when the blades 114 rotate in a certain direction. However, reversing the direction of rotation of the blades 114 is more likely to unjam the blades 114 when both the first and second edges 164, 166 are sharpened, since reversing the direction of rotation of the blades 114 may cut the tissue that was jamming the blades 114 rather than merely dislodging the tissue. Additionally, the blades 114 can cut tissue having directional grains more efficiently when the first and second edges 164, 166 are cutting edges. Further, when the first and second edges 164, 166 are cutting edges, reversing the direction the direction of rotation of the blades 114 allows a cutting edge that is fresh (e.g., not dulled) and has not been encumbered with tissue debris to cut the tissue. In an embodiment, at least one of the first or second edges 164, 166 form a cutting edge that is not sharpened. However, in such an embodiment, the cutting edge that is not sharpened can require additional force to cut the tissue than a cutting edge that is sharpened.

In an embodiment, as illustrated, at least one of the first or second edges 164, 166 can be curved, such as concavely curved relative to the direction of rotation that the first or second edge 164, 166 faces. The curved first or second edges 164, 166 can facilitate cutting of the tissue. In an embodiment, at least one of the first or second edges 164, 166 can be substantially straight.

In an embodiment, as previously discussed, the spokes 162 can extend from the central location of the blades 114 in a tapered manner. In other words, the distance between the first and second edges 164, 166 can increase or decrease the further the first and second edges 164, 166 are positioned from the central location of the blades 114. In such an embodiment, the space between portions of the first and second edges 164, 166 can be sufficiently great that a cutout 168 can be formed in the spoke 162. The cutout 168 can cause the spokes 162 to define a first minor edge 170 and a second minor edge 171. The first minor edge 170 can generally face the first rotational direction and the second minor edge 171 can generally face the second rotational direction. Similar to the first and second edges 164, 166, at least one (e.g., both) of the first minor edge 170 or the second minor edge 171 can be sharpened to form cutting edges of the spokes 162. Sharpening at least one of the first or second minor edge 170, 171 can increase the number of cutting edges on the blades 114. The increased number of cutting edges cut the tissue at least one of faster, into smaller particle sizes, or more uniformly.

In an embodiment, each of the plurality of blades 114 can be the same or substantially the same. In an embodiment, at least one of the plurality of blades 114 can be different. In an example, at least one of the plurality of blades 114 can include more or fewer spokes 162 as compared to at least one other blade 114. In an example, at least one of the plurality of blades 114 can be configured to cut in only the first rotational direction while at least one other blade 114 can be configured to cut only in the second rotational direction or both the first and second rotational directions. In an example, at least one of the plurality of blades 114 can include spokes 162 defining a cutout 168 while at least one other blade 114 does not define a cutout. The blades 114 can be different to enable the blades 114 to cut the tissue differently. For example, the first blades 114a can cut tissue exhibiting a smaller particle size than the second blades 114b. As such, the first blades 114a can be configured to cut smaller tissue (e.g., include more spokes 162) than the second blades 114b.

The blades 114 can be formed from any of the material disclosed herein. In an embodiment, the blades 114 can include a metal (“metal blades”). In an embodiment, the blades 114 can include a polymer (“polymer blades”), such as blades formed from polycarbonate, nylon, or glass reinforced polymers. In an example, the polymer blades are able to cut tissue substantially at least as effectively as the metal blades. In an example, the polymer blades can be easier to rotate than metal blades, since the polymer blades typically exhibit a lower coefficient of friction against the first disk 142, the blade retainer 144, and the second disk 146 than the metal blades. Further, the lower coefficient of friction causes the polymer blades to generate less heat than the metal blades, requires less saline solution be present in the chamber 112 than metal blades, or to be operated at higher rotational speeds than the metal blades. The heat generated by the blades during operation can, in some circumstances, damage viable cells. The lower coefficient of friction also allows the polymer blades to be secured more tightly against the first and second disks 142, 146 which, in turn, reduces the likelihood of jamming the blades 114 and creates a better cutting surface for cutting the tissue into substantially uniform particle sizes. In an example, the polymer blades do not conduct as much heat, in comparison, as metal blades. As such, the polymer blades exhibit localized heating at and/or near where the friction occurs thereby leaving other portions of the polymer blades at a lower temperature that is less likely to damage the viable cells. Further, the polymer blades are less likely to absorb the heat during operation and instead dissipate the heat into the tissue than the metal blades which causes the polymer blades to typically exhibit a lower surface temperature than the metal blades. In some circumstances, high surface temperatures of the blades 114 can damage viable cells. In an example, the polymer blades can be less likely to contaminate the tissue than the metal blades since forming the polymer blades (e.g., injection molding) can be likely to sterilize the polymer blades whereas forming the metal blades (e.g., stamping or machining) can be likely to introduce contaminates, such as oil, to the metal blades and fails to sterilize the metal blades. However, it is noted that metal blades can maintain a cutting edge thereof longer than the polymer blades and can exhibit a sharper cutting edge than the polymer blades. As such, the metal blades may exhibit a longer lifespan (e.g., thereby making the metal blades more reusable than the polymer blades) and cut the tissue into smaller particle sizes than the polymer blades.

As previously discussed, the blade assembly 110 can include at least one second disk 146 disposed between the blades 114. The second disk 146 can define a plurality of second apertures or holes 172 therein. The plurality of second holes 172 can be of a size (e.g., maximum lateral dimension) that is larger than the plurality of first holes 152. For example, the second blades 114b can cut the tissue into pieces until the tissue exhibits a size that is smaller than the second holes 172. Once the tissue exhibits a size that is smaller than the second holes 172, the tissue can pass through the second holes 172 and be cut by the first blade 114a. The first blade 114a can cut the tissue until the tissue exhibits a size that is smaller than the first holes 152.

The first holes 152 of the first disk 142 and the second holes 172 of the second disk 146 can facilitate cutting of the tissue. For example, the first and second holes 152, 172 can limit movement of the tissue as the blades 114 rotates which causes the blades 114 to cut the tissue rather than cause the tissue to rotate with the blades 114. As such, the first and second holes 152, 172 and the blades 114, collectively, can shear the tissue as the blades 114 rotate.

As previously discussed, the tissue cutter 106 can include one or more connection components that are configured to attach the blade assembly 110 to the shaft 108. In an embodiment, as illustrated, the one or more connection components includes an elongated bolt 174, a nut 175, and a screw 176. The elongated bolt 174 is configured to be at least partially disposed in the shaft 108. For example, the shaft 108 can define a recess 178 that is configured to receive at least a portion of the elongated bolt 174. The elongated bolt 174 can be configured to be attached to the nut 175 using any suitable method, such as press-fitting or threadedly attaching the elongated bolt 174 to the nut 175. In an example, the nut 175 can be configured to be partially disposed in the recess 178. In such an example, the recess 178 can exhibit a size that is sufficiently large to receive the nut 175 and/or the recess 178 can exhibit a shape that corresponds to the nut 175. Selecting the recess 178 to exhibit a shape that corresponds to the nut 175 can cause the nut 175 to rotate as the shaft 108 rotates. The screw 176 can be configured to be attached to the nut 175. The head of the screw 176 can exhibit a size that is larger than a central hole 179 of the blades 114 thereby allowing the screw 176 to couple the blades 114 and, by extension, the blade assembly 110 to the shaft 108. In an embodiment, the connection components can be different than the components illustrated in FIG. 1D. For example, the elongated bolt 174 and, optionally, the nut 175 can be integrally formed with the shaft 108. In such an example, the elongated bolt 174 and, optionally, the nut 175 can form an extension of the shaft 108 that extends from the distal portion 140 of the shaft 108. In another example, the screw 176 can exhibit an elongated shape that extends through the blade assembly 110 and is able to be directly attached to the shaft 108.

During operation, the first disk 142, the second disk 146, and the blade retainer 144 are configured to remain stationary while the blades 114 are configured to rotate. For example, the connection components can rotate as the proximal portion 138 of the shaft 108 rotates. Rotating the connection components also cause the blades 114 to rotate (i.e., the connection components transfer the rotation of the shaft 108 to the blades 114). In such an example, each of the blades 114 can define a central hole 179. The first disk 142 can define a first bearing hole 180, and the second disk 146 can define a second bearing hole 182. The central holes 179, the first bearing hole 180, and the second bearing hole 182 are configured to have a portion of the connection components (e.g., the nut 175) disposed therein. The first bearing hole 180 and the second bearing hole 182 are configured to bear against the connection components disposed therein such that the first disk 142 and the second disk 146 do not rotate when the connection components rotate. For instance, the first and second bearing holes 180, 182 can be the same size as or slightly larger in size than the portion of the connection components that are disposed therein. Meanwhile, the central holes 179 of the blades 114 can be press-fitted to the portion of the connection components (e.g., nut 175) that are disposed therein, can exhibit a shape that corresponds to the shape of the portion of the connection components that are disposed therein, or can otherwise be connected to the connection components in a manner that allows the blades 114 to rotate when the connection components rotate.

At least one of the first disk 142, the blade retainer 144, or the second disk 146 can include one or more features that are configured to prevent the first disk 142, the blade retainer 144, and the second disk 146 from rotating. For example, as illustrated, at least one of the first disk 142, the blade retainer 144, or the second disk 146 can include one or more divots 183 formed in an outer periphery thereof. The divots 183 can correspond to the one or more protrusions 122 formed in the canister 102. As such, the divots 183 and the protrusions 122 can prevent the first disk 142, the blade retainer 144, and the second disk 146 from rotating relative to the canister 102. Additionally, the divots 183 can allow at least one of the first disk 142, the blade retainer 144, or the second disk 146 to be adjacent to the at least one lateral surface 120 of the canister 102 such that tissue cannot flow around the blade assembly 110.

In an embodiment, the tissue cutter 106 can include a spring 184, such as a wave spring. The spring 184 can be disposed between the distal portion 140 of the shaft 108 and the blade assembly 110. For example, the spring 184 can be at least partially disposed in the recess 178 formed in the shaft 108. The spring 184 can maintain a constant pressure between the distal portion 140 of the shaft and the blade assembly 110 during operation of the tissue mincer 100. For example, the spring 184 can maintain the constant pressure even when the pressure applied to the blade assembly 110 by the tissue varies. The constant pressure between the distal portion 140 of the shaft and the blade assembly 110 can cause the distance between the blades 114 and the first disk 142, the blade retainer 144, and the second disk 146 to remain relatively constant. The relatively constant distance between the blades 114 and the first disk 142, the blade retainer 144, and the second disk 146 can prevent tissue from being stuck between the blades 114 and the first disk 142, the blade retainer 144, and the second disk 146. The tissue stuck between the blades 114 and the first disk 142, the blade retainer 144, and the second disk 146 can cause the blades 114 to become jammed and/or can be difficult to remove from the blade assembly 110. Further, the relatively constant distance between the blades 114 and the first disk 142, the blade retainer 144, and the second disk 146 can create good cutting surfaces which can facilitate cutting the tissue into substantially uniform particle sizes. Without the spring 184, the blades 114 may move (e.g., vibrate) relative to the first disk 142, the blade retainer 144, and the second disk 146 thereby causing the distance between the blades 114 and the first disk 142, the blade retainer 144, and the second disk 146 to vary.

The tissue mincer 100 includes an operation axis 186. The operation axis 186 is at least one (e.g., all) of generally parallel to the direction that the shaft 108 moves (e.g., up and/or down), perpendicular to the rotational direction of the blades 114, parallel to the longitudinal axis of the shaft 108, or parallel to the at least one lateral surface 120.

The tissue mincer 100 can be configured to operate in any suitable orientation. In an embodiment, the tissue mincer 100 can be configured to operate in a horizontal orientation (e.g., the operation axis 186 is not generally parallel to gravity) during operation. However, the tissue mincer 100 exhibiting the horizontal orientation has several problems, such as at least one of cutting the tissue with only a portion of the blades 114 at any given time, requiring more saline solution to mincer the tissue and remove tissue from the chamber 112, the blades 114 are more likely to jam, the tissue mincer is unable to form particles exhibiting substantially uniform particle size, or more tissue is likely to remain in the chamber 112 after allowing the tissue to leave the chamber 112 via the outlet 124 (e.g., the first disk 142, the blade retainer 144, the second disk 146, and/or the blades 114 can form a dam that prevents the tissue from leaving the chamber 112). In an embodiment, the tissue mincer 100 can be configured to operate in a vertical orientation (e.g., the operation axis 186 is longitudinal relative to the canister 102 and generally parallel to gravity). In such an embodiment, the canister 102 can include legs 189 on a surface that opposes the bottom surface 118, a flat surface that opposes the bottom surface 118, or any other suitable structure that allows the tissue mincer 100 to exhibit a vertical orientation. Operating the tissue mincer 100 in a vertical orientation can facilitate operation of the tissue mincer 100 for several reasons. For example, operating the tissue mincer 100 in a vertical orientation can allow substantially all of the blades 114 to cut the tissue at the same time since gravity causes the tissue to settle and be found directly below the blades 114 instead of off to one side of the operation axis 186, which can occur if the orientation of the canister is horizontal. Allowing substantially all of the blades 114 to cut the tissue at the same time can distribute the force of cutting the tissue across all the blades 114 thereby limiting or preventing the blades 114 from jamming. Additionally, operating the tissue mincer 100 in a vertical orientation can require less saline solution during operation and/or while removing the tissue from the tissue mincer 100 since gravity directs the tissue either toward a cutting region of the chamber 112 and/or toward the outlet 124.

FIG. 2 is an exploded isometric view of a tissue cutter 206, according to an embodiment. Except as otherwise disclosed herein, the tissue cutter 206 is the same as or similar to the other tissue cutters disclosed herein. For example, the tissue cutter 206 includes a shaft 208 and a blade assembly 210 including a disk 242, and a blade retainer 244. Further, the tissue cutter 206 can be used in any of the tissue mincers disclosed herein. For example, the tissue cutter 206 can be used with the canister 102 and the lid 104 shown in FIGS. 1A-1C.

Unlike traditional mechanical tissue mincers, the tissue cutter 206 can include only one blade 214. For example, traditional tissue mincers can require that a relatively large pressure is applied to the tissue to cut the tissue and/or relatively large pressure variations (e.g., relatively large maximum pressure) are applied to the tissue. The relatively large pressure and/or relatively large pressure variations can be caused by such traditional tissue mincers, which include stationary blades and/or mechanical tissue mincer being manually operated. To control the relatively large pressure and/or relatively large pressure variations, traditional tissue mincers require multiple blades and multiple disks behind the blades having decreasing hole sizes to spread the pressure throughout the blade assembly. However, as will be discussed in more detail below, the tissue cutter 206 can be connected to a motor that can control the pressure applied by the blade assembly 210 to the tissue. As such, the tissue cutter 206 can cut the tissue at a lower pressure than traditional tissue mincers and/or can control the pressure applied to the tissue which can allow the tissue cutter 206 to include only a single blade 214.

FIG. 3 is a schematic illustration of a system 387 that includes a tissue mincer 300, according to an embodiment. The tissue mincer 300 can include any of the tissue mincers disclosed herein. For example, the tissue mincer 300 can include a canister 302, a lid 304, and a tissue cutter 306. The tissue cutter 306 can include a shaft 308 and a tissue cutter (not shown, obscured).

The system 387 includes a motor 388. The motor 388 is operably coupled to a proximal portion 338 of the shaft 308. The motor 388 can be configured to rotate the proximal portion 338 of the shaft 308 and move the shaft 308 up and/or down (as shown with arrows). As such, the motor 388 can include a connection device that allows the motor 388 to be coupled to the proximal portion 338 of the shaft 308. For example, as illustrated, the proximal portion 338 includes a hexagonal shape, though it is noted that the proximal portion 338 can include other suitable shapes. In such an example, the connection device can define a recess exhibiting a size and shape that corresponds to the shape of the proximal portion 338. In an example, the motor 388 can include a chain, a belt, a clamp, or other suitable attachment device that allows the motor 388 to be operably coupled to the proximal portion 338 of the shaft 308.

In an embodiment, the motor 388 can be configured to controllably rotate the proximal portion 338 of the shaft 308 at a selected speed (e.g., at a constant speed or controllably varying the speed). The selected speed that the motor 388 rotates the proximal portion 338 of the shaft 308 can depend on the desired particle size of the tissue. For example, increasing or decreasing the selected speed that the motor 388 rotates the proximal portion 338 of the shaft 308 generally decreases or increases, respectively, the particle size of the minced tissue. In an embodiment, the motor 388 can be configured to controllably move the shaft 308 up and/or down at a selected speed (e.g., at a constant speed or controllably varying the speed). The selected speed that the motor 388 moves the shaft 308 up and/or down can also depend on the desired particle size of the tissue. For example, increasing or decreasing the selected speed that the motor 388 moves the shaft 308 up and/or down can generally increase or decrease, respectively, the particle size of the minced tissue. Further, the selected speed that the motor 388 moves the shaft 308 up and/or down can be selected to be sufficiently slow such that the tissue is unlikely to jam the blades. In an embodiment, the motor 388 can be configured to controllably move the shaft 308 up and/or down relative to the bottom of the canister 302 such that the blade assembly applies a selected pressure (e.g., a constant pressure or controllably varying the pressure) to the tissue by the blade assembly in a controlled manner. The selected pressure that is applied to the tissue by the blade assembly can be depend on the desired particle size of the tissue. For example, increasing or decreasing the selected pressure applied by the blade assembly the tissue generally increases or decreases, respectively, the particle size of the minced tissue. Further, the selected pressure applied by the blade assembly to the tissue can be controlled to prevent jamming of the blades and/or to allow the blade assembly to include a single blade. In either of the above embodiments, the system 387 can include at least one sensor that is configured to detect at least one of the following: the speed that the motor 388 rotates the proximal portion 338 of the shaft 308, the speed that the blades rotate, the speed that the motor 388 moves the shaft 308 up and/or down, or the pressure applied to the tissue by the blade assembly.

The motor 388 can include any suitable motor. In an example, the motor 388 can include a motor that is configured to be exposed to moisture, such as saline solution or bodily fluids. In an example, the motor 388 can be configured to be exposed to high temperatures, such as temperatures that allow the motor 388 to be at least partially sterilized. In an example, the motor 388 can be configured to be disposed in an autoclave.

The system 387 can include a controller 390 communicably coupled to the motor 388. The controller 390 can be configured to at least partially control the operations of the motor 388. For example, the controller 390 can include memory (e.g., non-transitory memory) storing one or more operational instructions and a processor configured to execute the operational instructions. The operational instructions can include instructions to rotate the proximal portion 338 of the shaft 308 at a selected speed, move the shaft 308 up and/or down at a selected speed, or apply a selected pressure to the tissue with the blade assembly. Executing the operational instructions with the processor can cause the controller 390 to direct the motor 388 to, for example, rotate the proximal portion 338 of the shaft 308 at the selected speed, move the shaft 308 up and/or down at the selected speed or a selected distance, or apply the selected pressure to the tissue with the blade assembly.

The system 387 can also include at least one of an input device 391 (e.g., touchscreen, mouse, keyboard, etc.) or an output device 392 (e.g., computer screen) that are operably coupled to the controller 390. The input device 391 can allow a user of the system 387 to input one or more operational instructions into the controller 390. The operational instructions inputted into the controller 390 can be stored by the memory and/or executed by the processor. In an example, the input device 391 can allow the user to input instructions to rotate the proximal portion 338 of the shaft 308 at a selected speed, move the shaft 308 up and/or down at a selected speed or a selected distance, or apply a selected pressure to the tissue with the blade assembly. The output device 392 can display information to the user and can include a user interface that allows the user to input information.

As previously discussed, the canister 302 can include an outlet 324. The outlet 124 can be fluidly coupled to a collection container 394. The collection container 394 can include any suitable container, such as a bag or a rigid container made of plastic or other suitable material. The outlet 324 can be indirectly fluidly coupled to the collection container 394 via at least one tube 395 or the outlet 324 can be directly coupled to the collection container 394.

In an embodiment, the system 387 includes a valve 396 that is configured to control fluid flow from the outlet 324 to the collection container 394. The valve 396 can include any suitable valve, such as a clamp or a ball valve. In an example, the valve 396 is disposed between and spaced from the outlet 324 and the collection container 394. In such an example, the valve 396 can include a clamp. In an example, the valve 396 can be integrally formed with the outlet 324 or the collection container 394.

In an embodiment, the system 387 can include a filter 398. In an example, the filter 398 can be configured to perform at least one of the following: prevent tissue exhibiting a particle size greater than a selected size or prevent certain contaminants from reaching the collection container 394. In an example, the filter 398 can direct tissue that cannot pass therethrough toward another collection container (not shown).

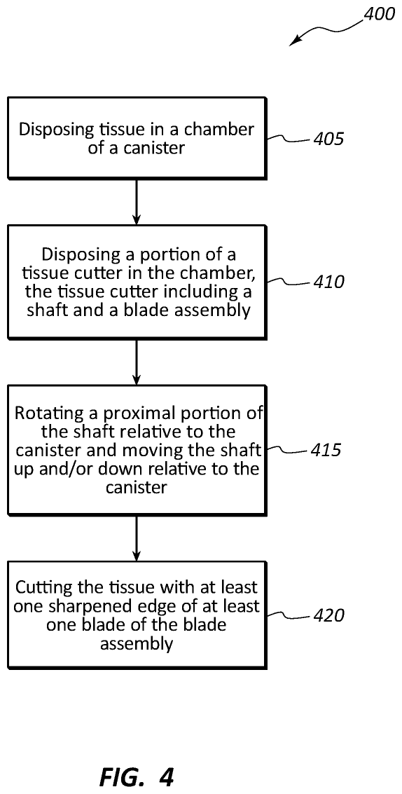

FIG. 4 is a flow chart of a method 400 of using any of the tissue mincers disclosed herein, according to an embodiment. The method 400 can include one or more acts as illustrated by one or more of acts 405, 410, 415, or 420. The acts described in acts 405-420 are for illustrative purposes only. In some examples, the acts may be performed in a different order, at least one act may be omitted, at least one act may be divided into additional act, at least one act may be modified or supplemented, at least two acts may be combined into a single block, or at least one additional block may be added.

The method 400 may begin with act 405, which recites “disposing tissue in a chamber of a canister.” Act 405 may be followed by act 410, which recites “disposing a portion of a tissue cutter in the chamber, the tissue cutter including a shaft and a blade assembly.” Act 410 may be followed by act 415, which recites “rotating a proximal portion of the shaft relative to the canister and moving the shaft up and/or down relative to the canister.” Act 415 may be followed by act 420, which recites “cutting the tissue with at least one cutting edge of at least one blade of the blade assembly.”

Act 405 recites “disposing tissue in a chamber of a canister.” For example, act 405 can include disposing any of the tissues disclosed herein in the chamber. Act 405 can also include disposing other materials in the chamber, such as saline solution or another liquid. For example, act 405 can include adding a volume of saline solution per gram of tissue of about 0 mL/g to about 30 mL/g, such as in ranges of about 0 mL/g to about 5 mL/g, about 2.5 mL/g to about 7.5 mL/g, about 5 mL/g to about 10 mL/g, about 7.5 mL/g to about 12.5 mL/g, about 10 mL/g to about 15 mL/g, about 12.5 mL/g to about 17.5 mL/g, about 15 mL/g to about 20 mL/g, about 17.5 mL/g to about 25 mL/g, or about 20 mL/g to about 30 mL/g. Since the tissue mincer can cut tissue exhibiting substantially uniform particle sizes and/or the vertical orientation of the of tissue mincer, the tissue mincer can use less saline solution that traditional mechanical tissue mincers. For example, the tissue mincer can use a volume of saline solution per gram of tissue of less than about 10 mL/g or less than about 5 mL/g. It is noted that the saline solution can be added to the tissue mincer at least one of before, during, or after one or more of acts 405, 410, 415, or 420.

Act 410 recites “disposing a portion of a tissue cutter in the chamber, the tissue cutter including a shaft and a blade assembly.” For example, act 410 can include disposing the blade assembly and the distal portion of the shaft in the chamber such that the blade assembly can be in a position to cut the tissue. Act 410 can also include disposing the shaft of the tissue cutter through the shaft opening of lid and attaching (e.g., reversibly attaching) the lid to the canister. Additionally, act 410 can include operably coupling the proximal portion of the shaft to a motor.

Act 415 recites “rotating a proximal portion of the shaft relative to the canister and moving the shaft up and/or down relative to the canister.” Rotating the proximal portion of the shaft causes the at least one blade of the blade assembly to rotate. For example, rotating the proximal portion of the shaft causes the at least one blade to rotate relative to at least one of a disk (e.g., a first disk or at least one second disk), the blade retainer, the canister, or the lid. Moving the shaft up and/or down also causes the blade assembly (e.g., the at least one blade of the blade assembly) to move up and/or down relative to at least one of the canister, the lid, or the tissue disposed in the chamber. In an example, act 415 includes moving the shaft up and/or down in a direction that is substantially parallel to gravity. In such an example, the tissue mincer exhibits a vertical orientation.

In an embodiment, act 415 can include at least one of rotating the proximal portion of the shaft or moving the shaft up and/or down with a motor. In such an example, the motor can control at least one of the following: the speed at which the proximal portion of the shaft rotates, the speed at which the shaft moves up and/or down, or the pressure applied by the blade assembly to the tissue. Controlling at least one of the following: the speed that the proximal portion of the shaft rotates, the speed that the shaft moves up and/or down, or the pressure applied by the blade assembly to the tissue, which can allow for control over the particle size of the minced tissue and can control the variation of the particle size such that the minced tissue exhibits a substantially uniform particle size. In an example, the motor can cause at least one of the following: rotation of the proximal portion of the shaft at a constant speed, movement of the shaft up and/or down at a predetermined speed, or application of a predetermined pressure to the tissue with the blade assembly. In such an example, the motor can cause the tissue mincer to form minced tissue exhibiting substantially the same particle size. In an example, the motor can controllably vary at least one of the rotational speed of the proximal portion of the shaft, the speed that the shaft moves up and/or down, or the pressure applied by the blade assembly to the tissue. In such an example, the motor can cause the tissue mincer to form minced tissue exhibiting substantially the same particle size or vary the particle size of the minced tissue in a controlled manner. In an embodiment, act 420 can cut the tissue until it exhibits an average particle size of about 100 μm to about 1 cm, such as in ranges of about 100 μm to about 500 μm, about 250 μm to about 750 μm, about 500 μm to about 1 mm, about 750 μm to about 1.5 mm, about 1 mm to about 2 mm, about 1.5 mm to about 3 mm, about 2 mm to about 4 mm, about 3 mm to about 6 mm, or about 5 mm to about 1 cm.

In an embodiment, act 415 can include at least one of rotating the proximal portion of the shaft or moving the shaft up and/or down manually. In such an embodiment, the particle size of the tissue can vary significantly since manually rotating the proximal portion of the shaft or manually moving the shaft up and/or down will results in variations in the rotational speed of the proximal portion of the shaft, variations in the speed that the shaft moves up and/or down, and variations in the pressure applied by the blade assembly to the tissue.

Act 420 recites “cutting the tissue with at least one cutting edge of at least one blade of the blade assembly.” For example, act 415 and 420 can include rotating the proximal portion of the shaft which, in turn, causes the at least one blade of the blade assembly to rotate and moving the shaft down. Rotating the blade and moving the shaft down can cause the rotating blade to contact the tissue and to cut the tissue. The blade can cut the tissue until the tissue is sufficiently small in size such that the tissue can move through the first disk (e.g., move from a cutting region to a non-cutting region of the chamber). The blade can continue to cut tissue until the blade assembly is adjacent to a bottom surface of the canister and a significant portion (e.g., most or substantially all) of the tissue is in the non-cutting region of the chamber. The shaft can then move upward while the blade continues to rotate or while the blade is stationary. Moving the shaft upward also moves the blade assembly upward and allows the minced tissue that is in the non-cutting region of the chamber to flow back into the cutting region of the chamber. After moving the shaft upward, the method 400 can, optionally, include repeating acts 415 and 420 to further decrease the particle size of the tissue.

In an embodiment, the method 400 can include adding a liquid, such as a saline solution, into the chamber. The liquid can be added to the chamber before, during, or after acts 415 and 420. The liquid can facilitate acts 415 and 420 by decreasing a viscosity of the minced tissue which facilitates moving the minced tissue from the cutting region to the non-cutting region of the chamber and decrease the likelihood that the tissue jams the at least one blade of the blade assembly. The liquid can also dissipate heat generated by the at least one blade and can act as a lubricant that decreases the amount of heat generated by the at least one blade. The liquid can also facilitate removal of the minced tissue from the chamber after acts 415 and 420. For example, the liquid can decrease the viscosity of the minced tissue which can facilitate the flow of the minced tissue into an outlet of the canister and can decrease the amount of minced tissue that remains on the surfaces of the canister and the tissue cutter. It is noted that a tissue mincer exhibiting a vertical orientation requires less liquid that a tissue mincer exhibiting a horizontal orientation. For example, the tissue mincer that exhibits a vertical orientation can use gravity to assist in flowing the minced tissue to the outlet. Also, the tissue mincer exhibiting a vertical orientation can have substantially all of the blades cut the tissue at the same time and can allow the minced tissue to flow through all of the blade assembly instead of only a portion of the blades, both of which cause the tissue mincer exhibiting the vertical orientation to require less liquid.

In an embodiment, the method 400 can include collecting the minced tissue from the canister. For example, collecting the minced tissue from the canister can include allowing the minced tissue to flow out of the canister via the outlet and into a collection container. Allowing the minced tissue to flow out of the canister can include opening a valve that is fluidly coupled to the outlet of the canister. In an example, collecting the minced tissue from the canister can include filtering the minced tissue with a filter and/or diverting some of the minced tissue towards a second collection container.

In an embodiment, the method 400 can include controlling at least a portion of the method 400 with a controller. In an example, the controller can be communicably coupled to the motor and can direct the motor to perform at least acts 415 and 420. In an example, the controller can also be coupled to one or more other components of the system, such as to the valve, and can at least partially control the operation of the other components of the system (e.g., direct the valve to open or close). In an example, the controller can include or be communicably coupled to an input device and/or an output device. In such an example, the method 400 can include inputting one or more operational instructions into the controller via the input device and/or providing information to the output device, as discussed in more detail above.

We claim:

1. A tissue mincer, comprising:
a canister including at least one end surface and at least one lateral surface extending from the at least one end surface, the at least one end surface and the at least one lateral surface defining at least a portion of a chamber, the canister defining an opening;
a lid configured to be attached to the canister and sized to be disposed over the opening; and
a tissue cutter comprising a shaft and a blade assembly, the shaft including a proximal portion and a distal portion longitudinally spaced from the proximal portion, the proximal portion configured to rotate and the distal portion extending into the chamber when the tissue mincer is fully assembled, the blade assembly including;
a first disk defining a plurality of holes, the first disk positioned adjacent to the distal portion of the shaft;
at least one blade spaced from the distal portion of the shaft by the first disk, the at least one blade including at least one cutting edge and an lateral periphery, wherein the at least one blade is configured to rotate relative to the first disk when the proximal portion of the shaft rotates; and
a blade retainer including a base portion and at least one outer wall extending from the base portion, the at least one outer wall configured to enclose at least a portion of the lateral periphery of the at least one blade, the blade retainer configured to be coupled to the first disk.

2. The tissue mincer of claim 1, wherein the canister is oriented vertically, and wherein the at least one end surface is a bottom surface.

3. The tissue mincer of claim 1, wherein the shaft and the canister are configured such that, during operation, the shaft and the at least one lateral surface of the canister are substantially perpendicular to gravity.

4. The tissue mincer of claim 1, wherein the at least one blade includes a polymer.

5. The tissue mincer of claim 1, wherein the at least one blade includes a metal.

6. The tissue mincer of claim 1, wherein the at least one blade includes a single blade.

7. The tissue mincer of claim 1, wherein the end surface includes one or more friction features that are configured to suppress movement of a tissue disposed in the chamber.

8. The tissue mincer of claim 7, further comprising a second disk positioned between the first blade and the second blade, the second disk defining a plurality of holes.

9. The tissue mincer of claim 1, wherein the at least one blade includes at least one first cutting edge generally facing a first rotational direction and at least one second cutting edge generally facing a second rotational direction that opposes the first rotational direction.

10. The tissue mincer of claim 1, wherein the first disk and the blade retainer are configured to remain stationary when the proximal portion of the shaft rotates.

11. The tissue mincer of claim 1, further comprising a spring at or near the distal portion of the shaft, the spring configured to apply a pressure between the shaft and the blade assembly.

12. A system, comprising:
a tissue mincer including:
a canister including at least one bottom surface and at least one lateral surface extending from the at least one bottom surface, the at least one bottom surface and the at least one lateral surface defining at least a portion of a chamber, the canister defining an opening;
a lid configured to be reversibly attached to the canister and sized to be disposed over the opening; and
a tissue cutter comprising a shaft and a blade assembly, the shaft including a proximal portion and a distal portion longitudinally spaced from the distal portion, the proximal portion configured to rotate and the distal portion extending into the chamber when the tissue mincer is fully assembled, the blade assembly including:
a first disk defining a plurality of holes, the first disk positioned adjacent to the distal portion of the shaft;
at least one blade spaced from the distal portion of the shaft by the first disk, the at least one blade including at least one cutting edge and a lateral periphery, wherein the at least one blade is configured to rotate relative to the first disk when the proximal portion of the shaft rotates; and
a blade retainer including a base portion and at least one outer wall extending from the base portion, the at least one outer wall configured to enclose at least a portion of the lateral periphery of the at least one blade, the at least one outer wall configured to be coupled to the first disk; and
a motor operably coupled to the proximal portion of the shaft, the motor configured to controllably at least one of:
controllably rotate the proximal portion of the shaft relative to the canister at a selected speed; or
controllably move the shaft up and/or down relative to the canister to at least one of move the shaft up and/or down relative to the canister at a selected speed or apply a selected pressure with the blade assembly to a tissue that is disposed in the chamber.

13. The system of claim 12, further comprising a controller configured to control an operation of at least the motor.

14. The system of claim 13, wherein the controller includes or is communicably coupled to an input device that allows a user to select a rotation speed of the shaft.

15. The system of claim 13, the controller includes or is communicably coupled to an input device that allows a user to select a speed that the shaft moves up and/or down relative to the canister or select a pressure that the blade assembly applies to the tissue disposed in the chamber.

16. A method of operating a tissue mincer, the method comprising:
disposing a tissue in a chamber of a canister of the tissue mincer, the canister including at least one bottom surface and at least one lateral surface extending from the at least one bottom surface, the at least one bottom surface and the at least one lateral surface at least partially defining the chamber;
disposing a portion of a tissue cutter of the tissue mincer in the chamber, the tissue cutter including a shaft and a blade assembly, the shaft including a proximal portion and a distal portion longitudinally spaced from the proximal portion, the proximal portion configured to rotate and the distal portion extending into the chamber, the blade assembly including:
a first disk defining a plurality of holes, the first disk positioned adjacent to the distal portion of the shaft;
at least one blade spaced from the distal portion of the shaft by the first disk, the at least one blade including at least one cutting edge and a lateral periphery; and
a blade retainer including a base portion and at least one outer wall extending from the base portion, the at least one outer wall configured to enclose at least a portion of the lateral periphery of the at least one blade, the at least one outer wall configured to be coupled to the first disk;
rotating the distal portion of the shaft relative to the canister and moving the shaft up and/or down relative to the canister, wherein:
rotating the distal portion of the shaft relative to the canister causes the at least one blade to rotate relative to the first disk; and
moving the shaft up and/or down relative to the canister causes the at least one blade to move up and/or down relative to the tissue disposed in the chamber; and
cutting the tissue with the at least one cutting edge of the at least one blade.

17. The method of claim 16, wherein moving the shaft up and/or down relative to the canister include moving the shaft up and/or down in a direction that is substantially parallel to gravity.

18. The method of claim 16, further comprising coupling the proximal portion of the shaft to a motor.

19. The method of claim 18, wherein rotating the proximal portion of the shaft relative to the canister includes rotating the proximal portion of the shaft with the motor at a selected speed.

20. The method of claim 18, wherein moving the shaft up and/or down relative to the canister includes at least one of:
moving the shaft up and/or down relative to the canister at a selected speed; or
applying a selected pressure applied to the tissue with the blade assembly.
